(19) United States
(12) Patent Application Publication
(10) Pub. No.: US 2010/0064476 A1
(43) Pub. Date: Mar. 18, 2010

(54) Hinge for fixing elements of motor vehicle interior

(75) Inventor: Ryszard Zeman, Bystra (PL)

Correspondence Address: FURR LAW FIRM, 2622 DEBOLT ROAD, UTICA, OH, 43080, US

(73) Assignee: GESTIND POLAND SP. Z O. O., Bielsko-Biała (PL)

(21) Appl. No.: 12/373,523

(22) PCT Filed: Jul. 13, 2006
(86) PCT No.: PCT/PL2007/000046

§ 371 Date: Jan. 12, 2009

(30) Foreign Application Priority Data
Jul. 13, 2006 (PL) P-380194
Jul. 9, 2007 (PL) PCT/PL2007/000046

(51) Int. Cl. E05F 1/08; E05D 11/10

(52) U.S. Cl. 16/297; 16/277

(57) ABSTRACT

The object of the invention resolves the issue of the construction of hinge for movable fixing of elements of motor vehicle interior, such as armrest, foldable shelf, or foldable table. The hinge (2) according to the invention has got the body (3) and the lid (4) connected with it forming space, inside of which, a slider-crank system is placed. The role of the crank is fulfilled by the element of vehicle interior (1), which is fixed by means of the mentioned hinge (2). The role of the slider is performed by the protrusion (6) placed at the end of lever (5), which through its other end is connected by articulation with the crank, i.e. the element of vehicle interior (1) where the point of connection of the lever (5) with the element of vehicle interior (1) is away from its axis of rotation by the distance (s). The protrusion (6) performs reciprocating motion in the oblong rectilinear slot (7) made in the body (3) and in the lid (4), where a single position of the protrusion (6) corresponds to the two extreme positions of the element of vehicle interior. The slot (8) is provided with at least one elastic locating element (9) directed to the inside, which is used for the setting of the protrusion (6) in a position corresponding to the extreme positions of the fixed element (1).

The object of the invention is the hinge devised for movable fixing of the elements of motor vehicle interior, such as vehicle seat armrest, foldable shelf, or foldable table.

From the EP 0604375 patent description, there is known a central armrest of motor vehicle rear seat, which is fixed between the two parts of the sectional back-rest of rear seat. The armrest may assume two positions: vertical and horizontal. The parts of the sectional back-rest are spaced out and they form a vertical space confirmed from the bottom by a couch, in which the central armrest is placed. The central armrest consists of an oblong body, which is usually made of foamed plastic and that has got a framework providing rigidity. On one end, the body is provided with a hinge, the purpose of which is to connect with the parts of the sectional back-rest from the side of a vertical cavity. The hinge consists of one pair of lateral connecting plates, where each of these has got a vertical slot, along which the end of a horizontal rod placed crosswise is shifted, where this rod holds the armrest with a swinging movement, and facilitating shifting. Vertical slots of the lateral plates in the top and lower parts are provided with elastic locating elements which set the ends of the transverse horizontal rod in extreme positions, i.e., corresponding to either vertical or horizontal placement of armrest.

Disadvantages of the known hinges as used in armrests with soft coat are, sometimes, defects of aesthetic nature in terms of resulting permanent creases of foamed plastic and of the covering layer which constitute the coat of the armrest in its working position, i.e. open, this being done by the elements of the mentioned hinge. These creases are especially visible once the armrest is folded into a vertical position.

As regards the armrests or other foldable elements with stiff coat, this translates into a necessity for the making of cutting in the whereabouts of the hinge, which means inaesthetic irregularity of the shape of a given element in its folded state, as well as disadvantageous visibility of the hinge, itself.

The purpose of the invention is to eliminate the faults of the known hinges by devising such hinge which in the scope of the feasible working positions may not cause deformations of the soft coat of elements of motor vehicle interior, and that may not require the making of inaesthetic cuts in stiff coats.

This objective has been attained by constructing the hinge which consists of a body and of a lid connected with it to form a single space inside of which, a system resembling slider-crank mechanism is placed, i.e. one that changes rotary motion into reciprocating motion. The role of crank is performed, in this case, by an element of motor vehicle interior which is fixed by means of the mentioned hinge. It can be, for instance, the armrest cushion which performs rotary motion roughly equal to ¼ of full rotation, i.e. in such scope as is performed by the armrest between extreme positions: lower—working position, and top—rest position. The role of the slider is performed by a protrusion placed at the end of lever, which through its other end is connected by articulation with the crank, i.e. the element of vehicle interior, for instance, the armrest cushion, where the point of connection of the lever with the armrest cushion is away from the axis of rotation of the armrest cushion. This protrusion performs the reciprocating motion in the oblong rectilinear slot made in the body or in the body and lid of the hinge, where a single position of the protrusion corresponds to the two extreme positions of the element of vehicle interior. The length of the slot is equal to the length of retilinear travel which is made by the protrusion. Preferably, the slot made in the lid has at least one known elastic locating element directed to the inside of the mentioned slot, which is used for setting the protrusion in a position corresponding to the extreme positions of the element of vehicle interior. As regards the armrest, it is possible to provide the slot in the lid with a greater number of known elastic locating elements which shall correspond to the intermediate positions of the armrest.

It is also feasible to provide the slot in the body with elastic locating elements, and then, it becomes possible to resign either from the lid, or from the making of the slot in the lid.

Preferably, the lever is in the form of a flat oblong element, the outline fragments of which make possible the cooperation with other elements of the fixing set.

Preferably, the lever is shaped in such a way so that in the working position of the element of vehicle interior, its edge is supported against bearing, for instance, a formed boss, with which the inside of the body is provided.

It is also feasible to use as the bearing the internal wall of the body, against which a part of the edge of the lever may be supported, so as to prevent the travel of the element of vehicle interior beyond the extreme lower position.

It is also feasible to restrain the working position of the element of vehicle interior through contact of the bearing surface connected with the element of vehicle interior with the bearing of the body of the hinge.

The advantage of the hinge according to the invention are its small dimensions, and especially its small thickness, which does not compromise the provision of high strength and reliability.

The object of the invention has been more closely explained with the example embodiment in the drawing, where:

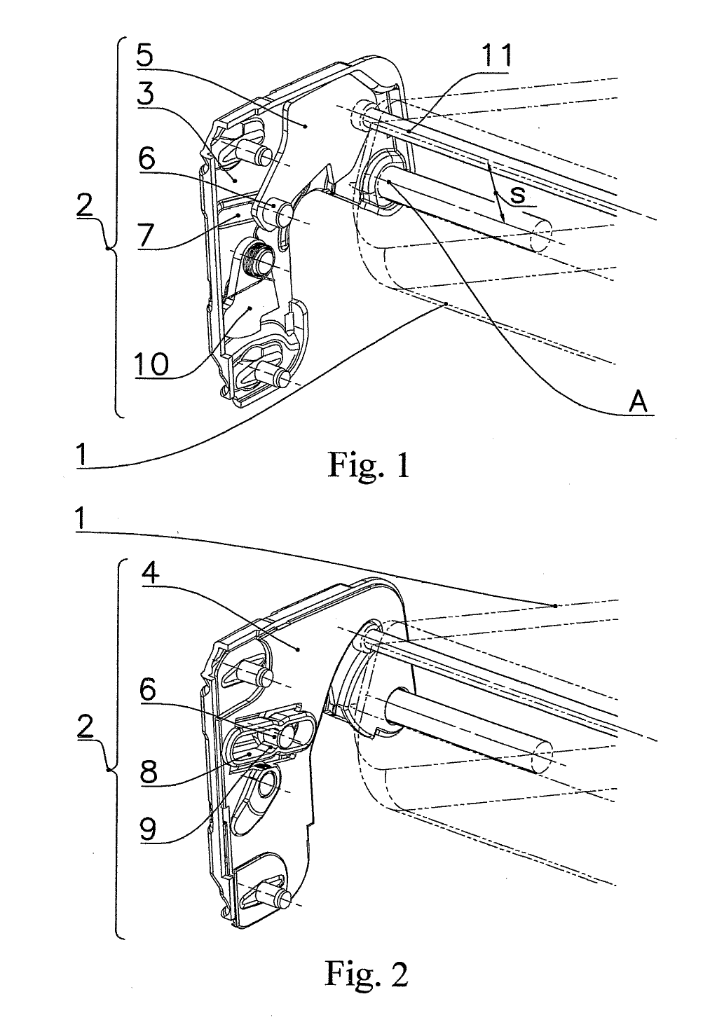

FIG. 1 presents a view of the inside of the body of the hinge as used in the armrest together with lever system, and

FIG. 2—the hinge from the side of the lid in the view.

The armrest according to the invention consists of a framework not shown in the drawing, on which a coat from elastic material is fixed, thus, forming the cushion 1; and of the hinge 2. The cushion 1 may comprise a utility container closed off by the lid. The hinge 2 has got the body 3, and the lid 4 connected with it forming a space, inside of which, the lever system is placed. Through the point A, there runs the axis of rotation of the cushion 1 of the armrest. Out-of-line with point A, at a distance s, there is the bearing axis 11 and the rotationally fixed lever 5 provided on both sides by the protrusion 6, which is placed so as to enable the making of reciprocating motion in the rectilinear slot 7 as made in the body 3 and in the slot 8 as made in the lid 4, overlapping with it. The slot 8 is provided with the pair of elastic locating elements 9 directed to the inside of the mentioned slot, which are used for the setting of the protrusion 6 in the position corresponding to the extreme positions of the armrest. The lever 5 is shaped as a flat, elongated element, the edge fragment of which is capable of cooperating with the inertial element 10 being rotationally placed on the axis in the whereabouts of the slot 7. Another fragment of edge of the lever 5 is to cooperate with the bearing in the form of part of the internal periphery of the body 3.

1-5. (canceled)

6. The binge for fixing the elements of motor vehicle interior, consisting of a casing provided with the slot furnished with elastic locating elements characteristic of that it has got the body (3) and the lid (4) connected with it, forming space, inside of which, there is the slider-crank mechanism placed as made up by the element of vehicle interior (1) to act as a crank with the rotation point (A), through which, there runs the axis of rotation of the element of vehicle interior {I); out-of-line with the point (A} at distance (s) the lever (5) is rotationally connected, on the other end of which, there is the protrusion (6) placed, fulfilling the role of a slider making reciprocating motion in the rectilinear slot (T) as made in the body (3) and the slot (8) as made in the lid (4) preferably overlapping with it, where at least one of the slots, (T) or (£), is provided with at least one known elastic locating element (9) directed to the inside of the mentioned slot, either (7) or (8).

7. The hinge as per claim 6 characteristic of that the lever (5) has the form of flat oblong element, the outline fragments of which make possible the cooperation with other elements of the hinge.

8. The hinge as per claim 6 characteristic of that the lever (5) in the working position of the element of vehicle interior (I) with a fragment of its edge is supported against a bearing which makes part of the inside of the body (3).

9. The hinge as per claim 7 characteristic of that the lever (5) in the working position of the element of vehicle interior (I) with a fragment of its edge is supported against a bearing which makes part of the inside of the body (3).

10. The hinge as per claim 6 characteristic of that as the bearing it has got a fragment of the internal periphery of the body (3).

11. The hinge as per claim 7 characteristic of that as the bearing it has got a fragment of the internal periphery of the body (3).

12. The hinge as per claim 8 characteristic of that as the bearing it has got a fragment of the internal periphery of the body (3).

13. The hinge as per claim 9 characteristic of that as the bearing it has got a fragment of the internal periphery of the body (3).

14. The hinge as per claim 6 characteristic of that the restriction of working position of the element of vehicle interior occurs through contact of the bearing surface connected with the element of vehicle interior (U) with the bearing of the body (3) of the hinge.

15. The hinge as per claims 7 characteristic of that the restriction of working position of the element of vehicle interior occurs through contact of the bearing surface connected with the element of vehicle interior (U) with the bearing of the body (3) of the hinge.
